(19) United States
(12) Patent Application Publication
(10) Pub. No.: US 2006/0186679 A1
(43) Pub. Date: Aug. 24, 2006

(54) Outside door handle device

(76) Inventors: Rudi Koelle, Sindelfingen (DE); Martin Lindmayer, Sulz (DE)

Correspondence Address: CROWELL & MORING LLP;INTELLECTUAL PROPERTY GROUP, P.O. BOX 14300, WASHINGTON, DC, 20044-4300, US

(21) Appl. No.: 10/543,626

(22) PCT Filed: Dec. 2, 2003
(86) PCT No.: PCT/EP03/13548

§ 371 Date: Feb. 7, 2006

(30) Foreign Application Priority Data
Jan. 29, 2003 (DE) 103 03 349.1

(51) Int. Cl. E05B 1/00

(52) U.S. Cl. 292/347

(57) ABSTRACT

An outside door handle device for a door of a motor vehicle, in particular a passenger vehicle, has a support and a pulling handle which is mounted at a bearing end by way of a pivot bearing on the support about a pivot axis. In order to reduce axial play in the pivot bearing, a bearing shaft is provided. The bearing shaft is fixed on the support, and a bearing sleeve is mounted in a manner such that it can be rotationally adjusted. The bearing end is placed onto the bearing sleeve.

### BACKGROUND AND SUMMARY OF THE INVENTION

The present invention relates to an outside door handle device for a door of a motor vehicle, in particular a passenger vehicle, having the features of the precharacterizing clause of claim 1.

An outside door handle device of this type is disclosed in German document DE 195 37 984 C2 and comprises a support which is arranged on an inside of the door skin. Furthermore, the outside door handle device has a pulling handle which is arranged on an outside of the skin and is mounted at a bearing end by means of a pivot bearing on the support in a manner such that it can be pivotally adjusted about an essentially vertical pivot axis. In the case of the known outside door handle device, the pivot bearing on the support comprises two bearing cheeks between which a bearing shaft extends, on the circumference of which an element for securing against pulling out is formed. The known bearing shaft is therefore not rotationally symmetrical with respect to the pivot axis. The bearing end of the pulling handle comprises a U-shaped mount which is placed onto the bearing shaft transversely with respect to the pivot axis, with a mating element for securing against pulling out which interacts with the bearing-shaft element for securing against pulling out being formed in a supporting flank of the mount.

Due to manufacturing tolerances, an axial distance, i.e. a distance measured in the longitudinal direction of the pivot axis, between the two bearing cheeks of the support is always larger than the axial extent of the bearing end of the pulling handle, which bearing end is placed onto the bearing shaft. Axial play of this type may also be advantageous for the installation of the outside door handle device, since the pulling handle can be retrospectively fitted from the outside through a corresponding opening in the door skin. This production-induced axial play is maintained in the ready fitted state of the outside door handle device and can be sensed during an actuation of the pulling handle. At least in the case of higher quality motor vehicles, this axial play of the pulling handle may be perceived by the particular user as a loss of comfort.

The present invention is concerned with the problem of specifying for an outside door handle device of the type mentioned at the beginning an improved embodiment which, in particular, provides increased comfort.

This problem is solved according to the invention by the subject matter of the independent claim. Advantageous embodiments are the subject matter of the dependent claims.

The invention is based on the general concept of fitting the bearing end of the pulling handle on a bearing sleeve which, for its part, is mounted rotatably on the bearing shaft. This enables the axial play which is required or which occurs to be reduced.

One development endeavors to eliminate the axial play which may be present, in the fitted state, with the aid of axially acting prestressing means. These prestressing means prestress the bearing end of the pulling handle into such a play-free position and, by means of the prestressing forces applied, prevent an axial adjustment of the pulling handle in the region of its bearing end relative to the support. Within the context of permissible misuse forces, no axial play can therefore be felt by the particular user of the pulling handle, which is perceived as a gain in comfort. In order to achieve this, in the case of the invention the bearing end of the pulling handle is placed onto a cylindrical bearing sleeve which is mounted about the pivot axis on a bearing shaft of cylindrical design, with a prestressing device which is supported in particular on the bearing sleeve stressing the bearing end axially against a shoulder of the bearing sleeve. The bearing end of the pulling handle is therefore no longer mounted directly on the bearing shaft, but rather is fixed on the bearing sleeve and is mounted indirectly on the bearing shaft via the bearing sleeve. If the prestressing device supports the reaction forces on the bearing sleeve, a closed force flux is produced within the bearing sleeve, as a result of which prestressing forces and reaction forces neutralize one another in the bearing sleeve. Accordingly, the bearing sleeve is free from forces in the axial direction to the outside, with the result that the axial prestressing of the bearing end does not produce any disadvantageous frictional effects for the rotatability of the bearing sleeve on the rotary shaft.

Of particular advantage is a development in which the prestressing device has a slide which is held on the support in a manner such that it can be displaced between an installation position and an operating position. In its operating position, the slide prestresses the bearing end of the pulling handle, which bearing end is placed onto the bearing sleeve, axially against the shoulder of the bearing sleeve. In its installation position, the slide permits an axial adjustment of the bearing end on the bearing sleeve. This design enables axial play to be provided for the bearing end in the installation position of the slide, thus simplifying the installation of the pulling handle. With the aid of a slide of this type, the axial prestressing can therefore be activated or deactivated, which facilitates the fitting and removal of the pulling handle.

According to one expedient development, the slide can extend on the support as far as a pull-out end of the pulling handle, which pull-out end is remote from the bearing end, and can have an actuating end there at which the slide can be actuated for displacement between its installation position and its operating position. This design enables a further considerable simplification of the installation to be obtained, since the actuating end in this development is situated in a relatively easily accessible section of the outside door handle device, as a result of which the slide can be actuated in particular from the outside.

Further important features and advantages of the invention emerge from the subclaims, from the drawings and from the associated description of the figures with reference to the drawings.

It goes without saying that the features which are mentioned above and those which have yet to be explained below can be used not only in the respectively stated combination but also in other combinations or on their own without departing from the scope of the present invention.

A preferred exemplary embodiment of the invention is illustrated in the drawings and is explained in more detail in the description below, with the same reference numbers referring to identical or functionally identical or similar components.

### BRIEF DESCRIPTION OF THE DRAWINGS

In the drawings, in each case schematically,

FIG. 1 shows a perspective view of an outside door handle device according to the invention;

FIG. 2 shows a sectional view through a pivot bearing corresponding to the section lines II in FIG. 1.

### DETAILED DESCRIPTION OF THE INVENTION

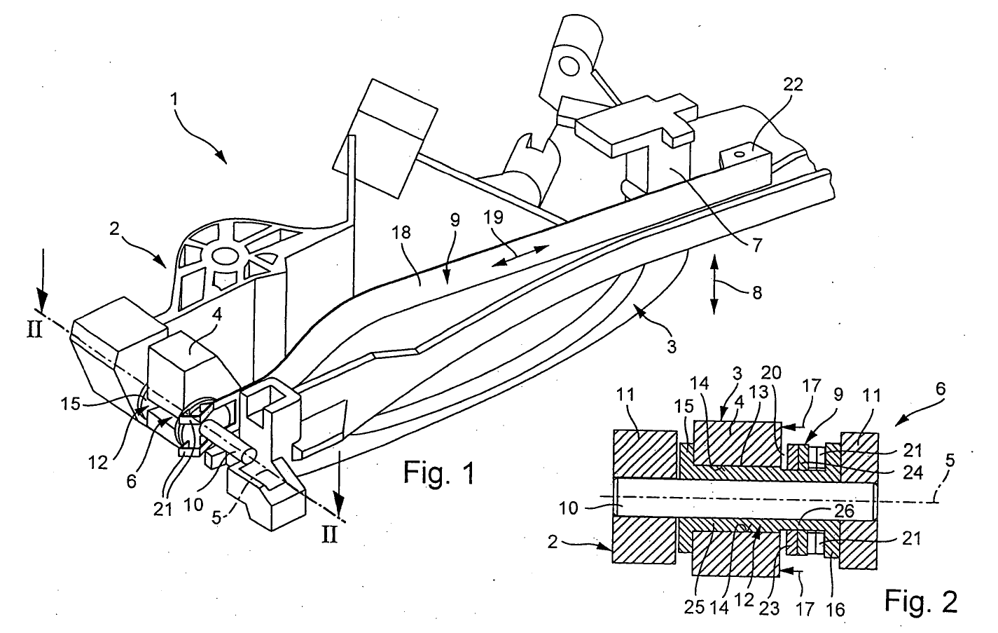

According to FIG. 1, an outside door handle device 1 of a door (not shown here) of a motor vehicle, in particular a passenger vehicle, has a support 2 (only part of which is illustrated here) and a pulling handle 3. In the fitted state, the support 2 is arranged in a known manner on an inside of the door skin while the pulling handle 3 is arranged in a known manner on an outside of the skin. In the region of the door outside handle device 1, the door skin usually has an installation opening which is closed or covered after installation by a covering element (not shown here) of the outside door handle device 1. The pulling handle 3 can be attached to the support 2 through this installation opening.

The pulling handle 3 has a bearing end 4 with which the pulling handle 3 is mounted on the support 2 in a manner such that it can be pivotally adjusted about a pivot axis 5. In the fitted state of the outside door handle device 1, this pivot axis 5 is arranged essentially vertically, i.e. the pivot axis 5 then extends more or less vertically. For the mounting of the bearing end 4 on the support 2, the outside door handle device 1 has a pivot bearing 6, the construction of which is explained in more detail further below with reference to FIG. 2.

The pulling handle 3 also has a pull-out end 7 which is remote from the bearing end 4 and is mounted on the support 2 and such that it can be pulled out with respect to a pull-out direction 8, which is symbolized in FIG. 1 by a double arrow. In this case, the pull-out device 8 extends in the circumferential direction with respect to the pivot axis 5. This means that the pulling handle 3, when it is actuated, is moved at its pull-out end 7 in the pull-out direction 8, with the entire pulling handle 3 being pivoted at its bearing end 4 about the pivot axis 5.

The outside door handle device 1 also has a prestressing device 9 which is explained in more detail further below, in particular with regard to FIG. 2.

According to FIG. 2, the pivot bearing 6 has a bearing shaft 10 which is of cylindrical design and is fastened to the support 2. For example, the bearing shaft 10, as here, is pressed into two mutually opposite bearing cheeks 11 formed on the support 2. The bearing shaft 10 extends here coaxially with the pivot axis 5 or the pivot axis 5 is defined by the position of the bearing shaft 10. The pivot bearing 6 also has a bearing sleeve 12 which is placed coaxially onto the bearing shaft 10. The bearing sleeve 12 is arranged here between the two bearing cheeks 11. In this case, the dimensions of the bearing shaft 10 and of the bearing sleeve 12 are expediently coordinated with one another in such a manner that the bearing sleeve 12 is mounted with comparatively little radial play on the bearing shaft in a manner such that it can rotate about the pivot axis 5. Furthermore, the dimensioning of the bearing sleeve 12 is expediently coordinated to the distance between the two bearing cheeks 11 such that a small axial play arises for the bearing sleeve 12. The axial end sides of the bearing sleeve 12 and the mutually facing insides of the bearing cheeks 11 are coordinated with one another with respect to surface composition and/or material selection in such a manner that a comparatively small coefficient of friction is produced between the bearing sleeve 12 and the bearing cheeks 11.

The bearing end 4 of the pulling handle 3 is then placed onto the bearing sleeve 12. For this purpose, the bearing end 4 is equipped here with a U-shaped mount 13 which has two mutually parallel supporting flanks 14. For the installation, the pulling handle 3 can be placed radially onto the bearing sleeve 12 with the open end of the mount 13 in front, the bearing sleeve 12 then penetrating between the supporting flanks 14 into the mount 13. Relatively exacting tolerances are expediently selected here, so that the bearing sleeve 12 can simultaneously touch the two supporting flanks 14.

The bearing sleeve 12 is equipped with a fixed shoulder 15 which protrudes radially from the bearing sleeve 12. In the present case, the shoulder 15 is formed at an axial end of the bearing sleeve, so that the shoulder 15 bears axially on the outside against one of the bearing cheeks 11. In the present case, the bearing sleeve 12 is also provided, at a distance from the shoulder 15, with a collar 16 which likewise protrudes radially from the bearing sleeve 12. The collar 16 is expediently also formed at an axial end of the bearing sleeve 12, so that it is adjacent here axially on the outside to the other bearing cheek 11.

The abovementioned prestressing device 9 is designed in such a manner that, in the fitted and operationally ready state of the outside door handle device 1, it prestresses the bearing end 4 of the pulling handle 3 axially against the collar 15. Corresponding prestressing forces are indicated in FIG. 2 by arrows 17. The bearing end 4 is therefore pressed axially against the axially inner side of the shoulder 15, as a result of which any axial play of the bearing end 4 relative to the bearing sleeve 12 is eliminated.

In the case of the embodiment shown here, the prestressing device 9 supports the reaction forces on the collar 16, as a result of which the axial prestressing forces 17 produced by the prestressing device 9 and the associated reaction forces neutralize one another within the bearing sleeve 12. The bearing sleeve 12 is therefore free from forces to the outside.

The prestressing device 9 comprises a slide 18 which is mounted on the support 2 in a manner such that it can be displaced between an installation position and an operating position in accordance with a double arrow 19 indicated in FIG. 1. In the operating position of the slide 18, the prestressing device 9 produces the desired prestressing forces 17, i.e. the prestressing device 9 is activated in the operating position of the slide 18. In contrast to this, the prestressing device 9 is deactivated in the installation position of the slide 18, i.e. the prestressing device 9 then produces only considerably reduced prestressing forces, if any at all, as a result of which the bearing end 4 can be axially adjusted on the bearing sleeve 12. In other words, in the installation position of the slide 18 the bearing end 4 again has a greater or lesser extent of axial play in relation to the bearing sleeve 12. This axial play may be of advantage for the installation and for the removal of the pulling handle 3. Furthermore, such axial play may be provided because of manufacturing tolerances. In FIG. 2, the slide 18 is in its installation position, with the result that the bearing end 4 has the abovementioned axial play which is represented in FIG. 2 by a corresponding gap 20.

The slide 18 is expediently equipped with at least one, here with two spring elements 21 (also compare FIG. 1). The spring elements 21 are designed, for example, as leaf springs which are shaped in such a manner that, in the operating position of the slide 18, they are firstly supported on the collar 16 and secondly (here indirectly) supported at the bearing end 4 and as a result produce the axial prestressing forces 17. In the installation position of the slide 18, the spring elements 21 are at such a distance from the bearing sleeve 12 with respect to the pivot axis 9 in the radial direction that they can no longer deploy their prestressing action. The spring elements 21 then release the bearing end 4 in the axial direction.

According to one advantageous embodiment, the spring elements 21 form an integral part of the slide 18, i.e. the slide 18 is produced integrally with the spring elements 21.

According to FIG. 1, the slide 18 has a comparatively elongate shape and, as a result, can extend on the support 2 approximately as far as the pull-out 7 of the pulling handle 3. An end of the slide 18 that is remote from the pivot bearing 6 is then expediently configured as actuating end 22 such that the slide 18 can be actuated manually or by means of a corresponding tool at its actuating end 22 for displacement between its installation position and its operating position. In the region of the pull-out end 7, the outside door handle device 1 has increased accessibility to the components arranged on the inside of the door skin, as a result of which an actuation of the slide 18 for fitting or removing the pulling handle 3 is facilitated.

According to FIG. 2, the prestressing device 9 has a sliding disk 23 and a pressure disk 24 which are both placed onto the bearing sleeve 12. The sliding disk 23 is positioned here in such a manner that, in the operating state of the outside door handle device 1, it bears against the bearing end 4 of the pulling handle 3, to be precise on its side facing away from the shoulder 15. In contrast to this, the pressure disk 24 is positioned in such a manner that the prestressing device 9 is supported on the pressure disk 24 in order to transmit the axial prestressing forces indirectly to the bearing end 4. In the present case, the pressure disk 24 is arranged axially between the sliding disk 23 and the spring elements 21. Accordingly, the spring elements 21 and the prestressing device 9 are supported, on the one hand, directly on the collar 16 and, on the other hand, indirectly at the bearing end 4 via the pressure disk 24 and via the sliding disk 23.

Both the sliding disk 23 and the pressure disk 24 can be displaced in the axial direction along the bearing sleeve 12.

Shoulder 15, bearing end 4 and sliding disk 23 are expediently coordinated with one another with respect to material selection and/or surface composition in such a manner that a predetermined coefficient of friction or predetermined coefficients of friction arises or arise between the abutting components. The coefficient or coefficients of friction are selected here in such a manner that the bearing end 4 which is axially clamped in place with the aid of the prestressing device 9 can still be displaced with sufficiently small forces radially with respect to the pivot axis 5 and parallel to the supporting flanks 14 and the bearing sleeve 12. Such radial displaceability of the bearing end 4 or of the pulling handle 3 may be of importance for a correct functioning of the outside door handle device 1. For example, the kinematics of the pulling handle may require such a radial mobility of the bearing end 4.

According to the particular embodiment shown in FIG. 2, the bearing sleeve 12 has two axial sections, namely a bearing section 25 and a prestressing section 26. The bearing section 25 is assigned to the bearing end 4 of the pulling handle 3 and has a larger diameter than the prestressing section 26 which is assigned to the prestressing device 9. The bearing end 4 is placed onto the bearing section 25, with the dimensions of the bearing end 4 and of the bearing section 25 being coordinated with one another with respect to the axial extent in such a manner that the bearing end 4, when it bears axially against the shoulder 15, protrudes axially over that end of the bearing section 25 which is remote from the shoulder 15, i.e. the axial extent of the bearing section 25 is smaller than the axial extent of the bearing end 4. The prestressing device 9 is arranged in the region of the prestressing section 26. Accordingly—depending on the embodiment of the prestressing device 9—spring elements 21 and/or sliding disk 23 and/or pressure disk 24 can be arranged on the bearing section 26.

The smaller diameter of the prestressing section 26 makes it possible to limit the axial displaceability of the sliding disk 23 and/or of the pressure disk 24 in the axial direction by that end of the bearing section 25 which is remote from the shoulder 15. This has the advantage that, if the pulling handle 3 is removed or not yet fitted, the axially movable components of the prestressing device 9, i.e. here spring elements 21, sliding disk 23 and pressure disk 24, are prepositioned on the prestressing section 26, as a result of which the introduction or placing of the bearing end 4 onto the bearing sleeve 12 is simplified.

1-10. (canceled)

11. An outside door handle device for a door of a motor vehicle, comprising:
a support which is arranged on an inside of a door skin, and
a pulling handle which is arranged on an outside of the door skin and mounted at one bearing end by way of a pivot bearing on the support so that it can be pivotably adjusted about an essentially vertical pivot axis,
wherein the pivot bearing has a cylindrical bearing shaft which is arranged coaxially with the pivot axis and is fixed on the support,
wherein the pivot bearing has a bearing sleeve which is placed coaxially onto the bearing shaft and is mounted on the latter so that it can be rotationally adjusted about the pivot axis, and
wherein the one bearing end of the pulling handle is placed onto the bearing sleeve.

12. The outside door handle device as claimed in claim 11, wherein a prestressing device is provided which prestresses the one bearing end axially against a radially protruding shoulder of the bearing sleeve.

13. The outside door handle device as claimed in claim 12, wherein the prestressing device has a slide which is secured on the support so that it can be displaced between an installation position and an operating position, wherein the prestressing device, in the operating position of the slide, prestresses the one bearing end of the pulling handle, which one bearing end is placed onto the bearing sleeve, axially against the shoulder of the bearing sleeve, and wherein the prestressing device, in the installation position of the slide, permits or simplifies an axial adjustment of the one bearing end on the bearing sleeve.

14. The outside door handle device as claimed in claim 13, wherein the slide has at least one axially acting spring which is activated in the operating position of the slide and prestresses the one bearing end of the pulling handle axially against the shoulder of the bearing sleeve, and which is deactivated in the installation position of the slide.

15. The outside door handle device as claimed in claim 14, wherein the at least one axially acting spring element, when the slide is in the operating position, is supported on a side facing the shoulder on a radially protruding collar of the bearing sleeve.

16. The outside door handle device as claimed in claim 14, wherein the at least one spring element is formed integrally on the slide.

17. The outside door handle device according to claim 13, wherein the slide extends on the support as far as a pull-out end of the pulling handle, wherein the pull-out end is remote from the one bearing end, and wherein the slide has an actuating end at which the slide can be actuated for displacement between its installation position and its operating position.

18. The outside door handle device as claimed in claim 12, wherein the one bearing end has a U-shaped mount with two parallel supporting flanks between which the bearing sleeve is arranged, wherein the prestressing device has a sliding disk which is placed onto the bearing sleeve and bears axially against the one bearing end of the pulling handle on a side facing away from the shoulder of the bearing sleeve, and wherein the shoulder, the sliding disk and the one bearing end are coordinated with one another with regard to at least one of material selection and surface composition in such a manner that the one bearing end which is prestressed axially against the shoulder can be adjusted radially with respect to the bearing sleeve and parallel to the supporting flanks.

19. The outside door handle device as claimed in claim 18, wherein the prestressing device has a pressure disk which is placed onto the bearing sleeve and bears axially against the sliding disk on a side facing away from the shoulder, and wherein the at least one spring element, in the operating position of the slide, is supported on a side of the pressure disk that faces away from the shoulder.

20. The outside door handle device as claimed in claim 12, wherein the bearing sleeve has two axial sections, namely a bearing section and a prestressing section, wherein the bearing section has a larger diameter than the prestressing section, wherein the one bearing end of the pulling handle is placed onto the bearing section, wherein an axial extent of the bearing section is smaller than an axial extent of the one bearing end placed onto it, and wherein the prestressing device is arranged on the prestressing section.

21. The outside door handle device as claimed in claim 15, wherein the at least one spring element is formed integrally on the slide.

22. The outside door handle device according to claim 14, wherein the slide extends on the support as far as a pull-out end of the pulling handle, wherein the pull-out end is remote from the one bearing end, and wherein the slide has an actuating end at which the slide can be actuated for displacement between its installation position and its operating position.

23. The outside door handle device according to claim 15, wherein the slide extends on the support as far as a pull-out end of the pulling handle, wherein the pull-out end is remote from the one bearing end, and wherein the slide has an actuating end at which the slide can be actuated for displacement between its installation position and its operating position.

24. The outside door handle device according to claim 16, wherein the slide extends on the support as far as a pull-out end of the pulling handle, wherein the pull-out end is remote from the one bearing end, and wherein the slide has an actuating end at which the slide can be actuated for displacement between its installation position and its operating position.

25. The outside door handle device as claimed in claim 13, wherein the one bearing end has a U-shaped mount with two parallel supporting flanks between which the bearing sleeve is arranged, wherein the prestressing device has a sliding disk which is placed onto the bearing sleeve and bears axially against the one bearing end of the pulling handle on a side facing away from the shoulder of the bearing sleeve, and wherein the shoulder, the sliding disk and the one bearing end are coordinated with one another with regard to at least one of material selection and surface composition in such a manner that the one bearing end which is prestressed axially against the shoulder can be adjusted radially with respect to the bearing sleeve and parallel to the supporting flanks.

26. The outside door handle device as claimed in claim 25, wherein the prestressing device has a pressure disk which is placed onto the bearing sleeve and bears axially against the sliding disk on a side facing away from the shoulder, and wherein the at least one spring element, in the operating position of the slide, is supported on a side of the pressure disk that faces away from the shoulder.

27. The outside door handle device as claimed in claim 13, wherein the bearing sleeve has two axial sections, namely a bearing section and a prestressing section, wherein the bearing section has a larger diameter than the prestressing section, wherein the one bearing end of the pulling handle is placed onto the bearing section, wherein an axial extent of the bearing section is smaller than an axial extent of the one bearing end placed onto it, and wherein the prestressing device is arranged on the prestressing section.

28. The outside door handle device as claimed in claim 14, wherein the one bearing end has a U-shaped mount with two parallel supporting flanks between which the bearing sleeve is arranged, wherein the prestressing device has a sliding disk which is placed onto the bearing sleeve and bears axially against the one bearing end of the pulling handle on a side facing away from the shoulder of the bearing sleeve, and wherein the shoulder, the sliding disk and the one bearing end are coordinated with one another with regard to at least one of material selection and surface composition in such a manner that the one bearing end which is prestressed axially against the shoulder can be adjusted radially with respect to the bearing sleeve and parallel to the supporting flanks.

29. The outside door handle device as claimed in claim 28, wherein the prestressing device has a pressure disk which is placed onto the bearing sleeve and bears axially against the sliding disk on a side facing away from the shoulder, and wherein the at least one spring element, in the operating position of the slide, is supported on a side of the pressure disk that faces away from the shoulder.

30. The outside door handle device as claimed in claim 14, wherein the bearing sleeve has two axial sections, namely a bearing section and a prestressing section, wherein the bearing section has a larger diameter than the prestressing section, wherein the one bearing end of the pulling handle is placed onto the bearing section, wherein an axial extent of the bearing section is smaller than an axial extent of the one bearing end placed onto it, and wherein the prestressing device is arranged on the prestressing section.
